(19) United States
(12) Patent Application Publication
(10) Pub. No.: US 2008/0147239 A1
(43) Pub. Date: Jun. 19, 2008

(54) Apparatus with Surface Information Displaying and Interaction Capability

(75) Inventors: Chin-Chong Chiang, Miaoli County (TW); Chiu-Wang Chen, Changhua County (TW); Ta-Chih Hung, Hsinchu County (TW); Yaw-Nan Lee, Hsinchu City (TW); Kuo-Shih Tseng, Taichung County (TW); Fu-Kuang Yeh, Taoyuan County (TW)

Correspondence Address: WPAT, PC, 7225 BEVERLY ST., ANNANDALE, VA, 22003, US

(73) Assignee: INDUSTRIAL TECHNOLOGY RESEARCH INSTITUTE, Hsinchu (TW)

(21) Appl. No.: 11/670,083

(22) Filed: Feb. 1, 2007

(30) Foreign Application Priority Data
Dec. 14, 2006 (TW) 095146826

(51) Int. Cl. G06F 19/00

(52) U.S. Cl. 700/264; 700/245

(57) ABSTRACT

The present invention provides an apparatus with surface information displaying, wherein a skin unit comprising a flexible display is covered on the surface of a moving object of the apparatus such that the surface of the apparatus is capable of displaying the information such us color, pattern or text immediately by software control. Meanwhile, the flexible display further has a layer of tactile sensing unit for detecting input of interacting signal. In addition, the moving object further integrates an environmental sensing device, an information identifying device or a combination of both and uses the environmental status, text information or audio/video, which are generated from the environmental sensing device or information identifying device, as an input signal through cable or wireless technology so as to generate responsive action through the flexible display or mechanism of the apparatus so that interactivities of the apparatus can be increased.

### FIELD OF THE INVENTION

The present invention relates to an interactive apparatus, and more particularly, to an apparatus capable of utilizing a flexible skin unit covering on the surface of a moving object of the apparatus to display interactive information. Preferably, the moving object further integrates sensing units, such as an tactile sensor, environmental sensing device or an information identifying device, for using the same to recognize an environmental status, a text, a pattern or a sound and thus convert those into corresponding signals or data to be used as input signals and transmitted to the apparatus by a wired or wireless means, by which the apparatus is enabled to response interactively and integratedly to those different input signals through the flexible skin unit and mechanism of the apparatus and thus the interactivities of the apparatus is increased.

### BACKGROUND OF THE INVENTION

With the prevalence of interaction moving objects and robots in our daily life, in contrast to current work in robotics that focus on motion control of robot, we want to build robots that can engage in meaningful interactions with humans, and thus concentrates on human-robot interactions. Most of the human-robot interaction studies use indication lamps, display panels, or movable mechanisms for imitating and simulating gestures, postures or facial expressions of a living being, however, they all overlook the workability of the shell surface of a robot, which accounts for most of the robot's appearance.

Generally, shell of any machine can only provide basic functions of covering, protecting, molding, etc., which is rarely capable of displaying messages or being used for interacting with operators. There are already many studies focus on broadening the usability of robot's shell. One of which is a robot disclosed in JP Pat. Pub. No. 2005-66766, in that the usability of the aforesaid robot's shell is broadened by the attachment of a displaying apparatus upon the shell of the robot. It is noted that, by the attaching of the displaying apparatus upon the robot's shell, not only an operator of the robot can acquired information monitoring by the robot at any viewing angle, but also the robot can be camouflaged by enabling the displaying apparatus to apply an inverse protection technique and thus coat a layer of protective color on the shell of the robot. However, the displaying apparatus can not generate patterns or colors on the shell of the robot in response to the robot's statuses, skin colors, or moods that can be used to interact with users. In addition, another such study reveals another robot, disclosed in JP Pat. Pub. No. 2006-026761, which has a plurality of flat panel displays attached upon the shell thereof. Although the usability of the aforesaid robot's shell is broadened by the plural flat panel displays, it is restricted by the rigid shapes of those flat panel displays and can only be used for message displaying.

Although there is a technique of human-robot interaction disclosed in JP Pat. Pub. No. 2003-265869, which provide a robot embellished with facial feature mechanism including eyebrows, ears, eyeballs, and eyelids, the mechanical control of such facial feature mechanism for expressing emotions and interacting with human is very complicated and difficult to achieve.

Therefore, it is in need of an apparatus with surface information displaying and interaction capability that is freed from the shortcomings of prior arts.

### SUMMARY OF THE INVENTION

The primary object of the present invention is to provide an apparatus with surface information displaying and interaction capability, that has a flexible display covering on the shell of the apparatus so as to utilize the flexibility of flexible displays for enabling the lifeless apparatus to express a variety of emotions and patterns by generating responsive actions through the flexible display and thus enhancing the interactivities of the apparatus.

It is another object of the invention to provide an apparatus with surface information displaying and interaction capability, that has a flexible display covering on the shell of the apparatus so as to use the flexible display to achieve human-robot interaction while being used as human machine interface since the flexible displays, which is the flexible and slice, can be integrated easily with a plurality of tactile sensors.

Yet, another object of the invention to provide an apparatus with surface information displaying and interaction capability, which integrates sensing units, such as an environmental sensing device or an information identifying device, for recognizing an environmental status, a text, a pattern or a sound and thus converting those into corresponding signals to be used as input signals and transmitted to the apparatus by a wired or wireless means, by which the apparatus is enabled to response interactively and integratedly to those different input signals and thus the interactivities of the apparatus is increased.

One another object of the invention to provide a lot of apparatuses with surface information displaying and interaction capability, all being networked to a communication network for enabling each to communicate with one another, within the network that each is capable of recognizing and integrating various information sensed from other apparatuses and operators and using the recognized information actively as its interactive inputs for enabling the apparatus to generate responsive actions through a flexible display covering the shell thereof that further enhance the interaction therebetween, either robot-to-robot, or robot-to-human.

To achieve the above objects, the present invention provides an apparatus with surface information displaying and interaction capability, comprising: a moving object; a skin unit, covering at least a part of the exterior surface of the moving object while having a flexible display formed therein; a perception unit, disposed on the moving object for receiving various perceptible signals; and a control unit, disposed on the moving object for controlling movements of the moving object and for controlling the skin unit to display an interactive information based on the signals of the perception unit.

In another preferred aspect, the present invention further provides an apparatus with surface information displaying and interaction capability, comprising: a moving object; a skin unit, covering at least a part of the exterior surface of the moving object while having a flexible display formed therein; an environmental sensing device, capable of detecting an ambient environment of the moving object and thus generating a sensing signal accordingly; and a control unit, disposed on the moving object for controlling movements of the moving object and for controlling the skin unit to display an interactive information based on the sensing signals from the environmental sensing device.

In further another preferred aspect, the present invention provides an apparatus with surface information displaying and interaction capability, comprising: a moving object; a skin unit, covering at least a part of the exterior surface of the moving object while having a flexible display formed therein; an information identifying device, for receiving and analyzing an electrical data and thus generating a resulting signal of the analysis accordingly; and a control unit, disposed on the moving object for controlling movements of the moving object and for controlling the skin unit to display an interactive information based on the resulting signal of the analysis.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a schematic diagram showing an apparatus with surface information displaying and interaction capability according to the present invention.

FIG. 2A is a cross sectional view of a skin unit used in an apparatus of the invention.

FIG. 2B is a schematic diagram showing a tactile sensing unit used in an apparatus according to a preferred embodiment of the invention.

FIG. 2C is a schematic diagram showing a tactile sensing unit used in an apparatus according to another preferred embodiment of the invention.

FIG. 3 is a function block diagram depicting a control unit used in an apparatus according to a preferred embodiment of the invention.

FIG. 4A is a schematic diagram showing facial expressions capable of being displayed by an apparatus with surface information displaying and interaction capability of the present invention.

FIG. 4B is a schematic diagram showing an operating apparatus according to a preferred embodiment of the invention.

FIG. 5A is a function block diagram depicting a perception input unit used in an apparatus according to a preferred embodiment of the invention.

FIG. 5B and FIG. 5C are schematic diagrams respectively showing a perception input unit communicating with an apparatus in a wired manner and a wireless manner.

FIG. 6 is a schematic diagram showing an operating apparatus according to another preferred embodiment of the invention.

FIG. 7 is a schematic diagram showing a group of apparatuses being networked to a network according to a preferred embodiment of the invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

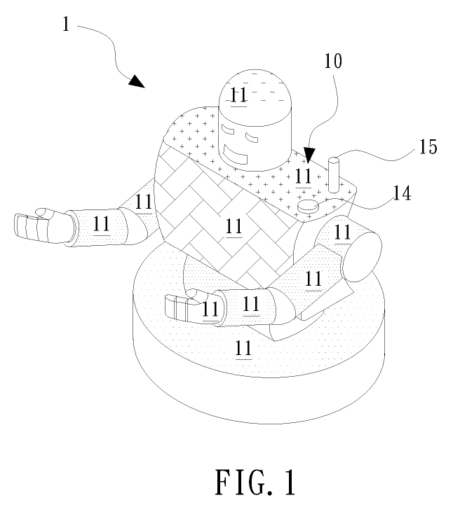

Please refer to FIG. 1, which is a schematic diagram showing an apparatus with surface information displaying and interaction capability according to the present invention. In FIG. 1, the apparatus 1 comprises a moving object 10, a perception unit 11 and a control unit, in which the moving object 10 either can be a robot, integrating a plurality of body modules for motion expression, selected from the group consisting of an industrial robotic arm, a mobile robot, an interactive robot, a guidance robot, a security robot, a homecare robot, an education robot, and an entertainment robot, or can be a device selected from the group consisting of a toy with motion expression ability, a portable electronic device with motion expression ability, a billboard of complicated curved surfaces with motion expression ability, and a device with specific motion expression ability.

As seen in FIG. 1, a skin unit 11 is adhere on the surface, or partial surface of the moving object 10, which substantially is composed of a flexible display for information displaying. In a preferred aspect, the flexible display can be a flexible OLED display or a flexible paper-like display that is thin, light-weighted and flexible, but is not limited thereby. Moreover, the flexible display is used for displaying an interaction data, including colors, patterns and text, but also is not limited thereby. It is noted that the patterns can be two-dimensional planar patterns or three-dimensional patterns.

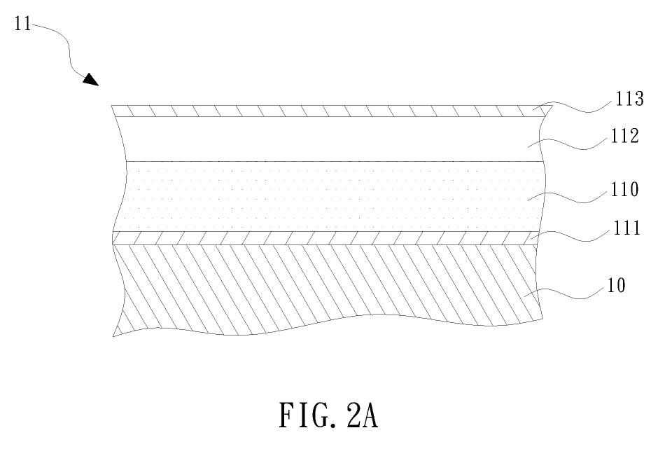

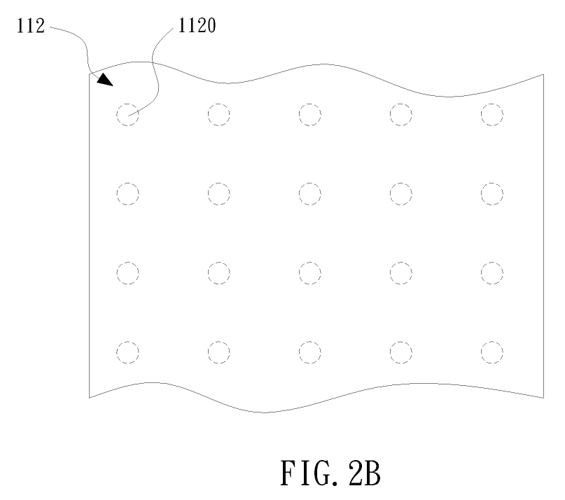

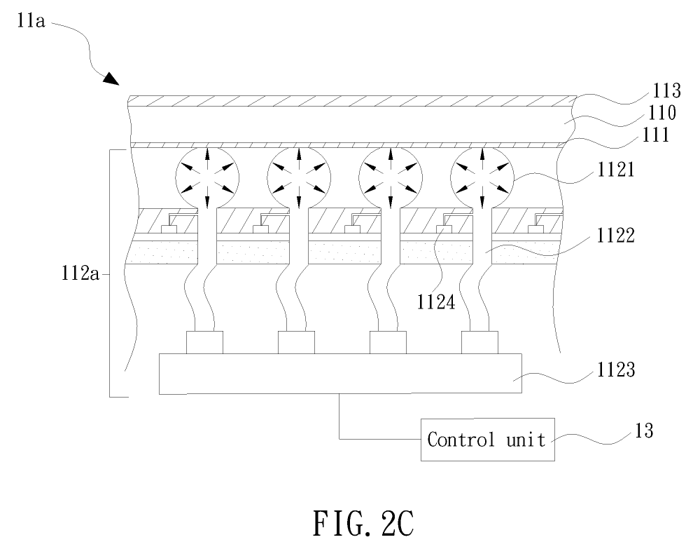

Please refer to FIG. 2A, which is a cross sectional view of a skin unit used in an apparatus of the invention. As the flexible display 110 is flexible and slice, the skin unit 11 can be fixedly adhere upon the moving object 10 by an adhesive 111 or other adhesive means. As seen in FIG. 2A, after adhering the flexible display 110 on the planer surface or curved surface of the moving object's shell, a layer of perception unit, including a tactile sensing unit 112, is further formed on the flexible display 110 that is used for detecting a touch contacting the skin unit 11 and generating a contact signal accordingly. In a preferred aspect, a protective layer 113 is further formed on the tactile sensing unit 112 for protecting the whole skin unit 11 form being damaged by scratch or bumping. When a touch is sensed by the tactile sensing unit 112 and the exact position of the touch is recognized by the tactile sensing unit 112, the moving object 10 can be enabled to respond to the touch by displaying colors, patterns or texts, etc., on the surface thereof. Thus, it is noted that a tactile sensing unit capable of recognizing the exact position of a touch can improve the interaction of the apparatus 10 with its ambient environment.

In a preferred embodiment, the tactile sensing unit 112 can be a thin film touch panel, selected from the group consisting of a resistive touch panel, a capacitive touch panel, an acoustic touch panel, an optical touch panel, and an electromagnetic induction touch panel, that can convert an exact position of a touch detected thereby into a contact signal. In addition, the tactile sensing unit 112 can be an array of tactile sensors, that is capable of measuring and detecting the magnitude and position of the touch while transmitting data of the touch relating to its magnitude and position to the control unit to be used as a basis of a logical decision performed by the control unit. It is noted that the array of tactile sensors can select to use either a single-point mechanical ON/OFF two-state switch or a multiple-point spring switch. Moreover, the tactile sensor array can be a device, capable of detecting the magnitude of a touch which outputting a contact signal accordingly, selected from the group consisting of a piezoelectric tactile sensor, a resistive tactile sensor, a capacitive tactile sensor or deformation of an elastic object. The aforesaid tactile sensors are all prior-arts to those skilled in the art and thus are not described further herein.

Please refer to FIG. 2B, which is a schematic diagram showing a tactile sensing unit used in an apparatus according to a preferred embodiment of the invention. As seen in FIG. 2B, the tactile sensing unit 112 is composed of an array of plural tactile sensors 1120, together capable of mapping a pressure distribution caused by a touch while transmitting data of the touch relating to its magnitude and position to the control unit to be used as a basis of a logical decision performed by the control unit.

Please refer to FIG. 2C, which is a schematic diagram showing a tactile sensing unit used in an apparatus according to another preferred embodiment of the invention. The tactile sensing unit 112a of FIG. 2C is a sensor having a plurality of flexible airbags 1121 distributed therein, each being used as a soft interface, capable of measuring and mapping a pressure distribution caused by the touch and detecting the position of the touch while transmitting data of the touch relating to its magnitude and position to the control unit 13 to be used as a basis of a logical decision performed by the control unit 13. As seen in FIG. 2C, each airbag 1121 is connected to a pressure supply 1123 by a channel 1122, whereas a pressure sensor 1124 is mounted on the channel 1122 of each airbag 1121 that is used for detecting a pressure exerting on the corresponding airbag 1121 and the position thereof while converting the detection into a signal to be received by the control unit 13.

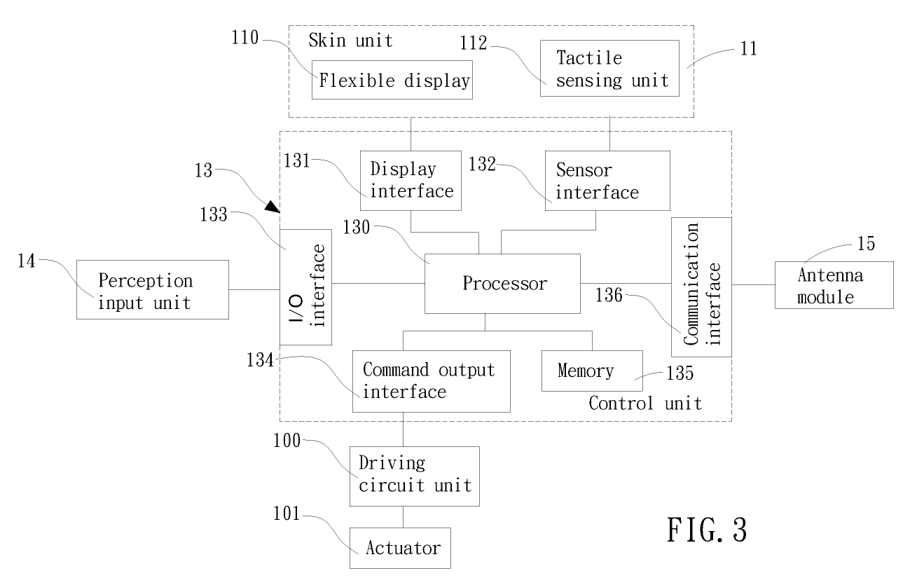

Please refer to FIG. 3, which is a function block diagram depicting a control unit used in an apparatus according to a preferred embodiment of the invention. As seen in FIG. 3, the control unit 13 is arranged on the moving object 10 for controlling the moving object 10 to perform the movement as well as the series of movements while controlling the skin unit 11 to display an interaction data in terms of a circumstance. Moreover, the control unit 13 is enabled to receive sensing signals from a tactile sensing unit 112 and input signals detected by other sensors as well as communication signals so as to issue a command of interaction effect accordingly.

In this embodiment, the control unit 13 is comprised of: a processor 130, for processing signals received by the control unit 13 and thus controlling the display of a skin unit 11 interactively; a display interface 131, used for connecting a flexible display 110 of the skin unit 13 to the processor 130; a sensor interface 132, used for connecting a tactile sensing unit 112 to the processor 130; an input/output (I/O) interface 133, for connecting other perception input unit 14 to the processor 130; a command output interface 134, for outputting a command of the processor 130 to a driving circuit unit 100; a memory 135, for data storage and registration; and a communication interface 136, connecting an antenna module 15 to the processor 130; wherein commands issued by the control unit 13 is send to an actuator 101 corresponding to the command by the use of the command output interface 134 and the driving circuit unit 100.

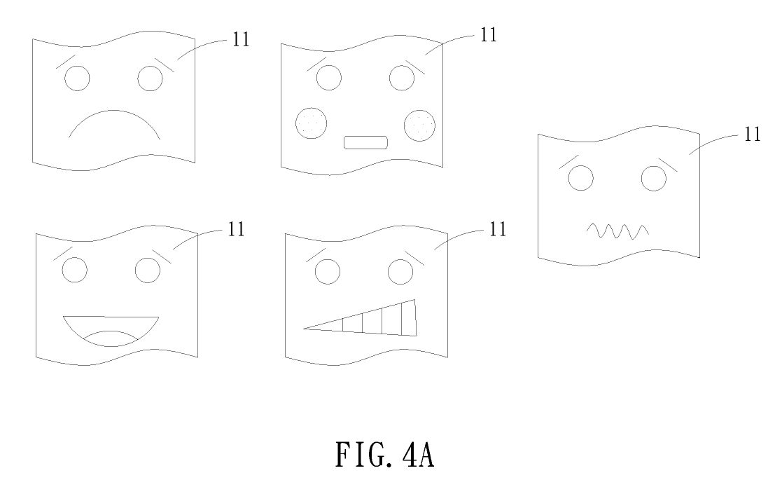

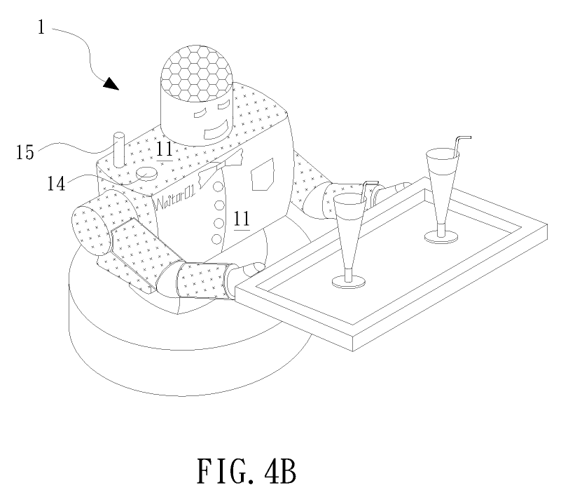

Please refer to FIG. 4A and FIG. 4B, which are respectively a schematic diagram showing facial expressions capable of being displayed by an apparatus with surface information displaying and interaction capability of the present invention, and a schematic diagram showing an operating apparatus of the invention. When a touch is sensed by the tactile sensing unit 112 of the skin unit 11 and the magnitude and position of the touch contacting the skin unit 112 is measured thereby, the control unit 13 is able to interact to the touch basing on the magnitude and position of the touch by issuing a command to corresponding actuators 101 for controlling the moving object 10 to perform a movement in response to the touch, or by enabling the flexible display 110 to display patterns of skin softness, textures, colors for mimicking a facial expression in response to the touch, as seen in FIG. 4A. Thus, the tactile sensing unit 112 is not only acting as a human-machine interface, but also as a human-robot interface.

As seen in FIG. 4A, when an operator touch the tactile sensing unit 112 of the skin unit 11, the skin unit 11 can respond to the touch by display a facial expression, such as happy, angry, sad, joy or embarrassing. When the moving object is substantially a toy, the joy of playing with such toy can be enhanced as the body color or even the dress of the toy can be changed simply by a touch. When the moving object is substantially a service robot, as seen in FIG. 4B, the robot is able to provide a more humanly and friendly service simply by changing the pattern shown on the flexible display for enable the robot to appear as it is wearing a tuxedo with welcoming smile on its face.

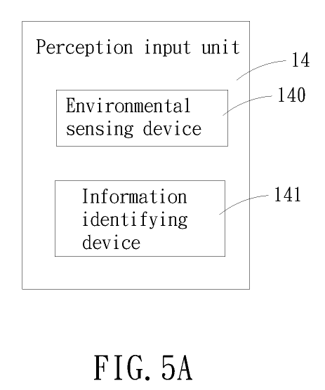

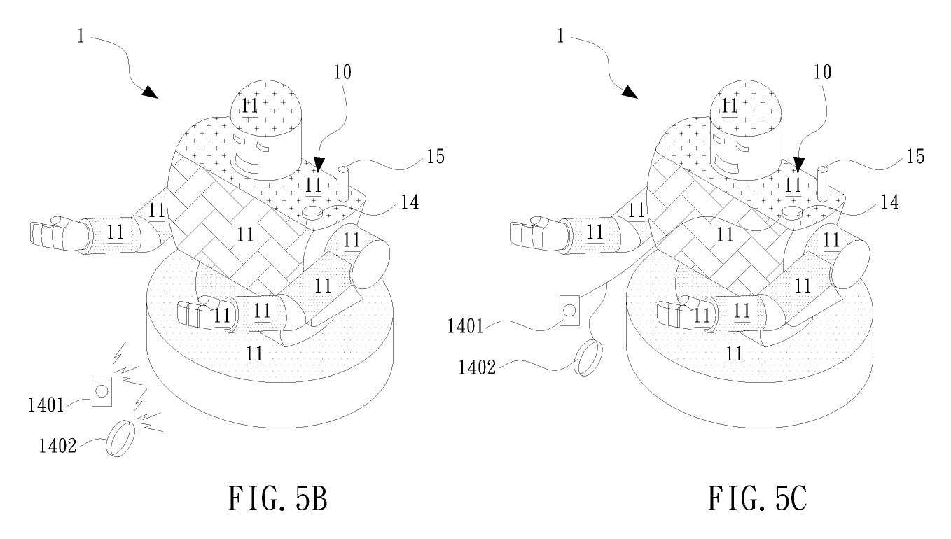

Please refer to FIG. 5A, which is a function block diagram depicting a perception input unit used in an apparatus according to a preferred embodiment of the invention. The perception input unit 14 is connected to the control unit 13 through the I/O interface 133, whereas the perception input unit 14 is arranged on the moving object 10, as seen in FIG. 5B. In FIG. 5A, the perception unit 14 is comprised of an environmental sensing device 140 and an information identifying device 141; in which the environmental sensing device 140 is capable of detecting an ambient environment of the moving object 10 and thus generating a sensing signal to the control unit 13 for enabling the same to control the skin unit 11 to response interactively in terms of a circumstance basing upon the sensing signals.

It is noted that the environmental sensing device 140 is capable of being enabled to detect one phenomenon selected from the group consisting of ambient temperature, ambient sound, ambient color, ambient atmosphere content, and ambient vibration and the combination thereof. For instance, when the environmental sensing device 140 is enabled to detect ambient temperature and detects a low temperature, the control unit 13 will direct the skin unit 11 to show a facial expression of shivering and a body of wearing heavy clothing. In FIG. 5B, the environmental sensing device 140 is further comprised of an input interface, used for receiving the input of a signal selected form the group consisting of a physiological signal of an operator, a signal relating to a mood change of the operator, and the combination thereof. For instance, when an operator is attached by a sensing pad 1401 or is wearing a sensing wrist band 1402, the physiological statuses of the operator, such as nervous or angry, can be detected and recognized by the apparatus 1 and consequently the apparatus can respond to such physiological statuses interactively by enabling its skin unit 11 to show colors and patterns corresponding to the physiological statuses for comforting, encouraging, or pacifying the operator's emotion. In FIG. 5B, the communication between the sensing pad 1401 and the sensing wrist band 1402 with the apparatus 1 is enabled by a wireless means, however, it can be enabled by a wired means also, as seen in FIG. 5C.

Moreover, the information identifying device 141 is capable of receiving and analyzing an input data and thus generating a resulting signal of the analysis to the control unit 13 so that the control unit 13 is able to base on the resulting signal of the analysis for controlling the skin unit 11 to response interactively to a movement and an interaction data in terms of a circumstance. In a preferred aspect, the information identifying device 141 is able to obtain the input data through Internet or a network, and the input information can be a text data, a vocal data, a video data or the combination thereof, e.g. an image of the ambient environment of the apparatus, an alarm for alerting the apparatus to aware a drop or elevation on the way it is moving toward, an alarm for alerting the apparatus to aware a narrowing on the way it is moving toward, a sound of a defined vocal signal, voice command, and so on. When receiving a text input, the information identifying device 141 is capable of recognizing and analyzing the text while defining the meaning of the text or the categorizing result of the text as the resulting signal of the analysis. When receiving a vocal input, the information identifying device 141 is capable of recognizing and analyzing the vocal data to specify designated words and sounds while defining the meaning of the words/sounds or the categorizing result of the words/sounds as the resulting signal of the analysis. Moreover, when receiving a video input, the information identifying device 141 is capable of recognizing and analyzing the video input, no matter it is a dynamic video data or static image picture, to specify designated patterns and features while defining the meaning of the patterns/features or the categorizing result of the patterns/features as the resulting signal of the analysis.

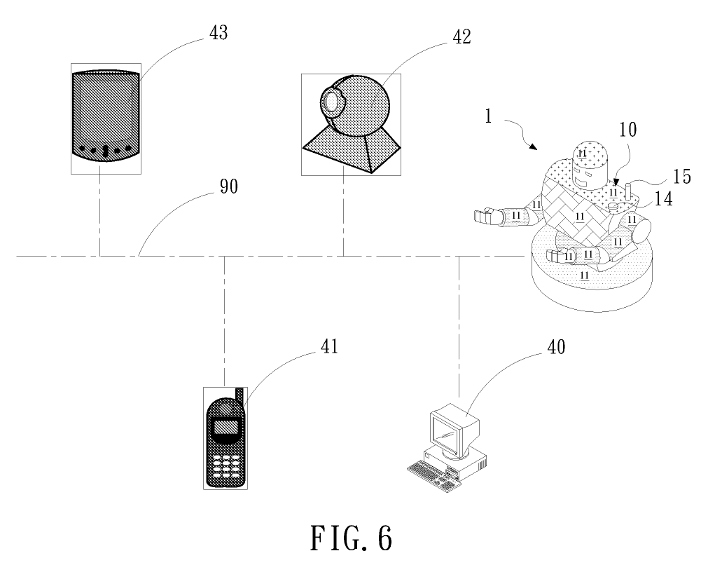

Please refer to FIG. 6, which is a schematic diagram showing an operating apparatus according to another preferred embodiment of the invention. As seen in FIG. 6, an apparatus is networked to a plurality of input devices, such as the computer 40, the cellular phone 41, the PDA 43 and the camera 42, through a network 90 in a wireless manner or a wired manner. In a preferred aspect, the antenna module 15 of the apparatus 1 can be used for enabling data communication in a wireless manner. By the aforesaid network 90, the plural input devices are able to transmit data of text, audio, video to the apparatus 1 and thus the apparatus 1 can respond to those data by performing the interactive gesture and posture or by displaying an interactive data on its skin unit.

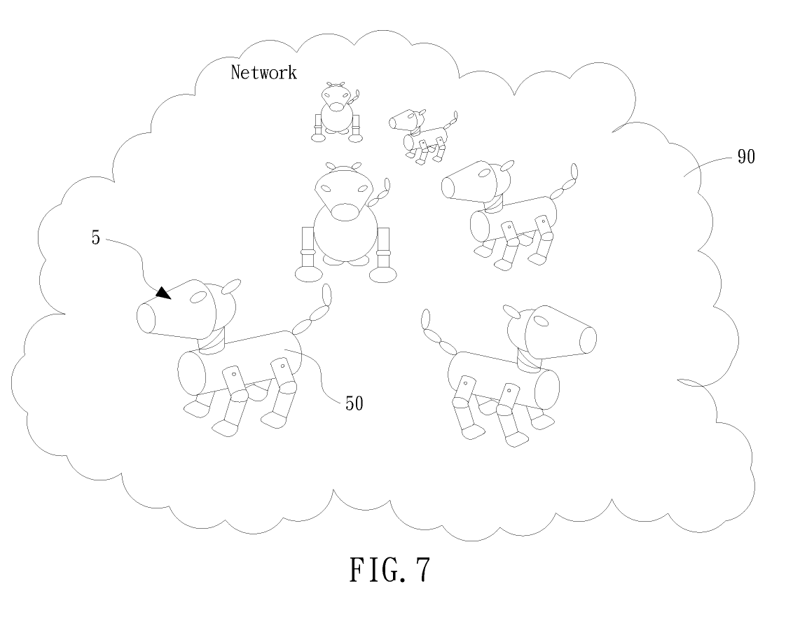

Please refer to FIG. 7, which is a schematic diagram showing a group of apparatuses being networked to a network according to a preferred embodiment of the invention. In FIG. 7, a group of apparatuses is being networked to a network 90, whereas each of such apparatuses is comprised of a moving objects for perform a single movement or a series of movements and each apparatus 5 is able to communicate with one another by a communication signal. In this preferred embodiment, the apparatus 5 is substantially a robotic dog having a skin unit 50 covering the surface thereof. It is noted that the skin unit 50 is similar to those illustrated hereinbefore and thus is not described further herein. The moving object of each robotic dog is further comprised of a control unit, capable of controlling the moving object to perform the movement as well as the series of movements while performing an analysis upon the communication signal for controlling the group of the robotic dogs to interact with one another. It is noted that the control unit is similar to that illustrated in FIG. 3 and thus is not described further herein.

In FIG. 7, the interaction between the group of apparatuses and that between each apparatus with operators can be enabled by a wireless manner or a wired manner, by which signals of interaction can be transmitted therebetween and consequently causes the skin unit of each apparatuses to display an interaction information on its flexible display 50. It is noted that each of the group of apparatuses is able to communicate with one another through the network 90. Similarly, each of the group of apparatuses can be equipped with aforesaid tactile sensing unit, environmental sensing device and information identifying device, by which each is capable of recognizing and integrating various information sensed from other apparatuses and operators and using the recognized information actively as its interactive inputs for enabling the apparatus to generate responsive actions through a flexible display covering the shell thereof that further enhance the interaction therebetween, either robot-to-robot, or robot-to-human.

To sum up, the apparatus of the invention has a flexible display covering on the shell of the apparatus so as to utilize the flexibility of flexible displays for enabling the lifeless apparatus to express a variety of emotions and patterns by generating responsive actions through the flexible display and thus enhancing the interactivities of the apparatus. Moreover, as the perception sensing unit can be a thin film touch panel, a tactile sensing unit, an environmental sensing device, an information identifying device or the combination thereof, a variety of perceptions can be detected by the apparatus and thus the interaction ability of the apparatus is enhanced.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An apparatus with surface information displaying and interaction capability, comprising:
a moving object;
a skin unit, covering at least a part of the exterior surface of the moving object while having a flexible display formed therein;
a tactile sensing unit, disposed on the skin unit for enabling the same to detect and measure the magnitude and position of a touch contacting the skin unit; and
a control unit, disposed on the moving object for controlling movements of the moving object and for controlling the skin unit to display an interactive information based on the sensing signals from the tactile sensing unit.

2. The apparatus of claim 1, wherein the moving object is a robot, integrating a plurality of body modules for motion expression, selected from the group consisting of an industrial robotic arm, a mobile robot, an interactive robot, a guidance robot, a security robot, a homecare robot, an education robot, and an entertainment robot.

3. The apparatus of claim 1, wherein the moving object is a device selected from the group consisting of a toy with motion expression ability, a portable electronic device with motion expression ability, a billboard of complicated curved surfaces with motion expression ability, and a device with specific motion expression ability.

4. The apparatus of claim 1, wherein the flexible display is a device, capable of displaying colors and gray levels, selected form the group consisting of a flexible electrical display and a flexible paper-like display.

5. The apparatus of claim 1, wherein the interaction data includes colors, patterns, and text which are displayed by two-dimension or three-dimension.

6. The apparatus of claim 1, wherein the tactile sensing unit is a tactile sensor, selected from the group consisting of a single-point tactile sensor, a multiple-point tactile sensor, and an array tactile sensor, capable of measuring and detecting the magnitude and position of the touch while transmitting data of the touch relating to its magnitude and position to the control unit to be used as a basis of a logical decision performed by the control unit.

7. The apparatus of claim 6, wherein the tactile sensor is a device, capable of detecting the magnitude and position of a touch, selected from the group consisting of a piezoelectric tactile sensor, a resistive tactile sensor, a capacitive tactile sensor and deformation of an elastic object.

8. The apparatus of claim 6, wherein the tactile sensor is substantially a sensor having a plurality of flexible airbags distributed therein, each being used as a soft interface, capable of measuring and mapping a pressure distribution caused by the touch and detecting the position of the touch while transmitting data of the touch relating to its magnitude and position to the control unit to be used as a basis of a logical decision performed by the control unit.

9. An apparatus with surface information displaying and interaction capability, comprising:
a moving object;
a skin unit, covering at least a part of the exterior surface of the moving object while having a flexible display formed therein;
an environmental sensing device, capable of detecting an ambient environment of the moving object and thus generating a sensing signal accordingly; and
a control unit, disposed on the moving object for controlling movements of the moving object and for controlling the skin unit to display an interactive information based on the sensing signal of the environmental sensing device.

10. The apparatus of claim 9, wherein the moving object is a robot, integrating a plurality of body modules for motion expression, selected from the group consisting of an industrial robotic arm, a mobile robot, an interactive robot, a guidance robot, a security robot, a homecare robot, an education robot, and an entertainment robot.

11. The apparatus of claim 9, wherein the moving object is a device selected from the group consisting of a toy with motion expression ability, a portable electronic device with motion expression ability, a billboard of complicated curved surfaces with motion expression ability, and a device with specific motion expression ability.

12. The apparatus of claim 9, wherein the flexible display is a device, capable of displaying colors and gray levels, selected form the group consisting of a flexible electrical display and a flexible paper-like display.

13. The apparatus of claim 9, wherein the interaction data includes colors, patterns, and text which are displayed by two-dimension or three-dimension.

14. The apparatus of claim 9, wherein the environmental sensing device is capable of being enabled to detect one phenomenon selected from the group consisting of ambient temperature, ambient sound, ambient color, ambient atmosphere content, and ambient vibration and the combination thereof.

15. The apparatus of claim 9, wherein the environmental sensing device further comprises an input interface, used for receiving the input of a signal selected form the group consisting of a physiological signal of an operator, a signal relating to a mood change of the operator, and the combination thereof.

16. An apparatus with surface information displaying and interaction capability, comprising:
a moving object;
a skin unit, covering at least a part of the exterior surface of the moving object while having a flexible display formed therein;
an information identifying device, for receiving and analyzing an electrical data and thus generating a resulting signal of the analysis accordingly; and
a control unit, disposed on the moving object for controlling the movements of the moving object and for controlling the skin unit to display an interactive information based on the resulting signal of the analysis.

17. The apparatus of claim 16, wherein the moving object is a robot, integrating a plurality of body modules for motion expression, selected from the group consisting of an industrial robotic arm, a mobile robot, an interactive robot, a guidance robot, a security robot, a homecare robot, an education robot, and an entertainment robot.

18. The apparatus of claim 16, wherein the moving object is a device selected from the group consisting of a toy with motion expression ability, a portable electronic device with motion expression ability, a billboard of complicated curved surfaces with motion expression ability, and a device with specific motion expression ability.

19. The apparatus of claim 16, wherein the flexible display is a device, capable of displaying colors and gray levels, selected form the group consisting of a flexible electrical display and a flexible paper-like display.

20. The apparatus of claim 16, wherein the interaction data includes colors, patterns, and text which are displayed by two-dimension or three-dimension.

21. The apparatus of claim 16, wherein the information identifying device is capable of recognizing and analyzing a text while defining the meaning of the text or the categorizing result of the text as the resulting signal of the analysis.

22. The apparatus of claim 16, wherein the information identifying device is capable of recognizing and analyzing a vocal data to specify designated words and sounds while defining the meaning of the words/sounds or the categorizing result of the words/sounds as the resulting signal of the analysis.

23. The apparatus of claim 16, wherein the information identifying device is capable of recognizing and analyzing a dynamic video data or static image picture to specify designated patterns and features while defining the meaning of the patterns/features or the categorizing result of the patterns/features as the resulting signal of the analysis.
